(19) United States
(12) Patent Application Publication
(10) Pub. No.: US 2009/0256446 A1
(43) Pub. Date: Oct. 15, 2009

(54) ULTRASONIC MOTOR

(75) Inventor: Tomoki Funakubo, Tama-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/419,519

(22) Filed: Apr. 7, 2009

(30) Foreign Application Priority Data
Apr. 9, 2008 (JP) 2008-101759

(51) Int. Cl. H02N 2/12

(52) U.S. Cl. 310/323.16

(57) ABSTRACT

An ultrasonic motor, which rotates a rotor by elastic movement generated by simultaneously exciting vertical oscillation and twisted oscillation in an ultrasonic oscillator, by using expanding and contracting oscillations of a multilayer piezoelectric element formed by laminating two kinds of piezoelectric sheet, is configured as follows. Namely, the multilayer piezoelectric element is formed by alternately laminating a first piezoelectric sheet and a second piezoelectric sheet. The first piezoelectric sheet is provided with a first internal electrode, which is divided into two or more parts, and each divided part is exposed to a peripheral edge of the piezoelectric sheet. The second piezoelectric sheet is provided with an internal electrode, which has a polarity reverse to the first internal electrode, and is divided into two or more parts, and each divided part is exposed to a peripheral edge of the piezoelectric sheet.

### CROSS-REFERENCE TO RELATED APPLICATIONS

This application is based upon and claims the benefit of priority from prior Japanese Patent Application No. 2008-101759, filed Apr. 9, 2008, the entire contents of which are incorporated herein by reference.

### BACKGROUND OF THE INVENTION

1. Field of the Invention

The present invention relates to an ultrasonic motor using an ultrasonic oscillator driven from an electromechanical transducer element.

2. Description of the Related Art

In recent years, an ultrasonic motor has received attention as a new motor replacing an electromagnetic motor. An ultrasonic motor has the following advantages compared with a conventional electromagnetic motor.

(1) High torque without using gears

(2) Savable at power off

(3) High resolution

(4) Quiet

(5) No magnetic noise, and not influenced by noise Jpn. Pat. Appln. KOKAI Publication No. 9-85172 discloses the following technique related to such an ultrasonic motor.

Jpn. Pat. Appln. KOKAI Publication No. 9-85172 discloses an ultrasonic oscillator comprising a rod-shaped elastic body; elastic holding bodies which are provided on the side of the rod-shaped elastic body, and formed in one piece with the rod-shaped elastic body; a pair of multilayer piezoelectric elements which is held by the elastic holding bodies at both ends, and has a displacement direction forming a predetermined acute angle to the longitudinal direction of the rod-shaped elastic body, in which the multilayer piezoelectric elements are inclined in the direction opposing each other; oscillation detection piezoelectric elements provided between the multilayer piezoelectric elements and the elastic holding bodies; and a frictional element provided on an end face of the rod-shaped elastic body, wherein ultrasonic elliptical oscillation is exited in the frictional element provided on the end face of the rod-shaped elastic body by simultaneously exciting vertical oscillation and twisted oscillation by supplying said pair of multilayer piezoelectric elements an alternating voltage having a predetermined frequency and voltage corresponding to a phase or amplitude of an output signal from the oscillation detection piezoelectric elements.

According to the ultrasonic oscillator disclosed in the Jpn. Pat. Appln. KOKAI Publication No. 9-85172, even if an ambient temperature changes, an optimum frequency can be traced by using a signal from an oscillation detection piezoelectric element, and vertical and bending oscillation modes can be easily and independently detected.

However, in the technique disclosed in the Jpn. Pat. Appln. KOKAI Publication No. 9-85172, it is necessary to interpose an insulating plate as an insulating ceramics between the multilayer piezoelectric element as a driving piezoelectric element and the oscillation detection piezoelectric element. This complicates the structure of the ultrasonic oscillator.

### BRIEF SUMMARY OF THE INVENTION

The present invention has been made in the above circumstances. It is an object of the invention to provide an ultrasonic motor, which is configured to be driven at an optimum frequency even if an ambient temperature and load are changed, and is constructed simply, and is reducible in costs and dimensions.

In order to achieve the above object, according to a first aspect of the invention, there is provided an ultrasonic motor, which rotates a rotor by elastic movement generated by simultaneously exciting vertical oscillation and twisted oscillation in an ultrasonic oscillator, by using expanding and contracting oscillations of a multilayer piezoelectric element formed by laminating two kinds of piezoelectric sheet, wherein the multilayer piezoelectric element is formed by alternately laminating a first piezoelectric sheet and a second piezoelectric sheet, the first piezoelectric sheet has a first internal electrode which is divided into two or more parts, and each divided part is exposed to a peripheral edge of the piezoelectric sheet, and the second piezoelectric sheet has an internal electrode which has a polarity reverse to the first internal electrode, and is divided into two or more parts, and each divided part is exposed to a peripheral edge of the piezoelectric sheet.

According to the invention, it is possible to provide an ultrasonic motor, which is configured to be driven at an optimum frequency even if an ambient temperature and load are changed, and is constructed simple, and is reducible in costs and dimensions.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a top view of an ultrasonic oscillator constituting an ultrasonic motor according to a first embodiment of the invention;

FIG. 2 is a view (front view) of an ultrasonic oscillator viewed from the α direction in FIG. 1;

FIG. 3 is a view (rear view) of an ultrasonic oscillator viewed from the β direction in FIG. 1;

FIG. 4 is a view (right-side view) of an ultrasonic oscillator viewed from the γ direction in FIG. 1;

FIG. 5 is a view (left-side view) of an ultrasonic oscillator viewed from the δ direction in FIG. 1;

FIG. 6 is an exploded view of an ultrasonic oscillator viewed from the α direction in FIG. 1;

FIG. 7 is an exploded view of a multilayer piezoelectric element;

FIG. 8 is an external view of a multilayer piezoelectric element;

FIG. 9 is a view showing a system configuration of a control unit of an ultrasonic motor;

FIG. 10 is a view showing mode displacement in resonant vertical oscillation;

FIG. 11 is a view showing mode displacement in resonant twisted oscillation;

FIG. 12 is a side view of an ultrasonic motor using an ultrasonic oscillator;

FIG. 13 is an exploded view of an ultrasonic motor using an ultrasonic oscillator;

FIG. 14 is an exploded view showing a configuration of a multilayer piezoelectric element according to a second embodiment of the invention;

FIG. 15 is an external view of a multilayer piezoelectric element;

FIG. 16 is an exploded view showing a configuration of a multilayer piezoelectric element according to a third embodiment of the invention;

FIG. 17 is an external view of a multilayer piezoelectric element;

FIG. 18 is an exploded view showing a configuration of a multilayer piezoelectric element according to a fourth embodiment of the invention; and

FIG. 19 is an external view of a multilayer piezoelectric element.

### DETAILED DESCRIPTION OF THE INVENTION

### First Embodiment

Hereinafter, an explanation will be given of an ultrasonic motor according to a first embodiment with reference to the accompanying drawings.

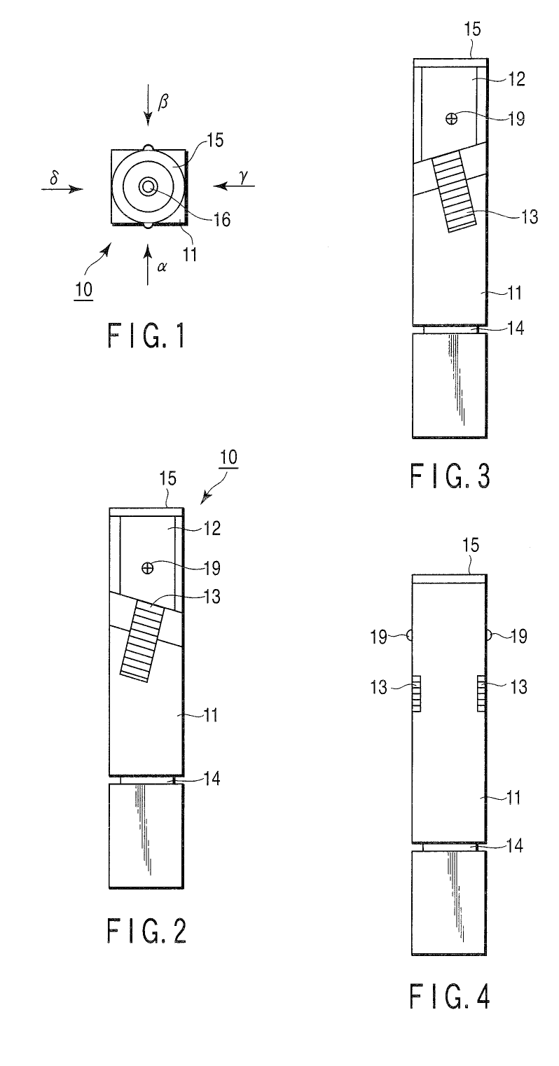

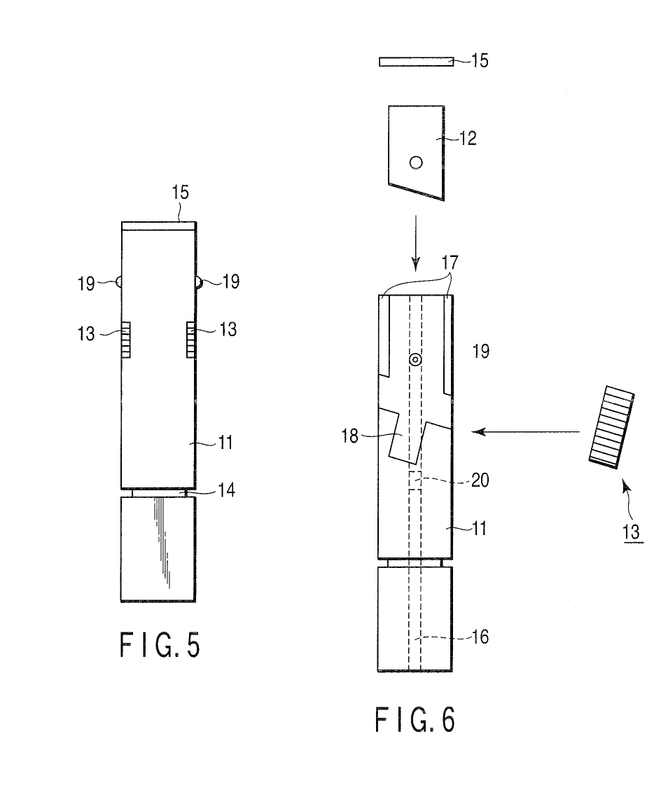

FIG. 1 is a top view of an ultrasonic oscillator 10 constituting an ultrasonic motor according to a first embodiment. FIG. 2 is a view (front view) of the ultrasonic oscillator 10 viewed from the α direction in FIG. 1. FIG. 3 is a view (rear view) of the ultrasonic oscillator 10 viewed from the β direction in FIG. 1. FIG. 4 is a view (right-side view) of the ultrasonic oscillator 10 viewed from the γ direction in FIG. 1. FIG. 5 is a view (left-side view) of the ultrasonic oscillator 10 viewed from the δ direction in FIG. 1. FIG. 6 is an exploded view of the ultrasonic oscillator 10 viewed from the α direction in FIG. 1.

The ultrasonic oscillator 10 has a square rod-shaped elastic body 11 made of brass (O material of C2801P). The square rod-shaped elastic body 11 has a size of 9 mm×9 mm×40 mm, for example, and has a groove 14 with the depth of 2 mm all around at the position of 16 mm from the lower end.

On the front and rear sides of the square rod-shaped elastic body 11, a pair of multilayer piezoelectric element 13 as an electromechanical transducer element is held at an inclination angle of 15° with respect to the length direction of the square rod-shaped elastic body 11. The piezoelectric element 13 has a size of 2 mm×3.1 mm×9 mm, for example.

At the distal end of the square rod-shaped elastic body 11, a frictional element 15 comprising a grindstone formed by dispersing alumina ceramic grind particles in a circular phenol resin is fixed. At the central part of the square rod-shaped elastic body 11, a through hole 16 is formed along the length direction, and a screw 20 is provided in a part of the through hole (exactly, at the node position of vertical oscillation), as shown in FIG. 6.

The multilayer piezoelectric element 13 is explained in detail. FIG. 7 is an exploded view of the multilayer piezoelectric element 13.

In the multilayer piezoelectric element 13, a piezoelectric plate 31 and a piezoelectric plate 32 are alternately laminated as shown in FIG. 7. Such a multilayer structure may be made by using an adhesive, or by baking the laminated plates in one piece.

More specifically, the piezoelectric plate 31 has two divided internal electrodes A+ and B+ as shown in FIG. 7. Similarly, the piezoelectric plate 32 has two divided internal electrodes A− and B− as shown in FIG. 7.

The internal electrodes (A+ and A−) are used for driving. The internal electrodes (B+ and B−) are used for detecting oscillation. The functions of driving and detecting oscillation assigned to the internal electrodes may be different.

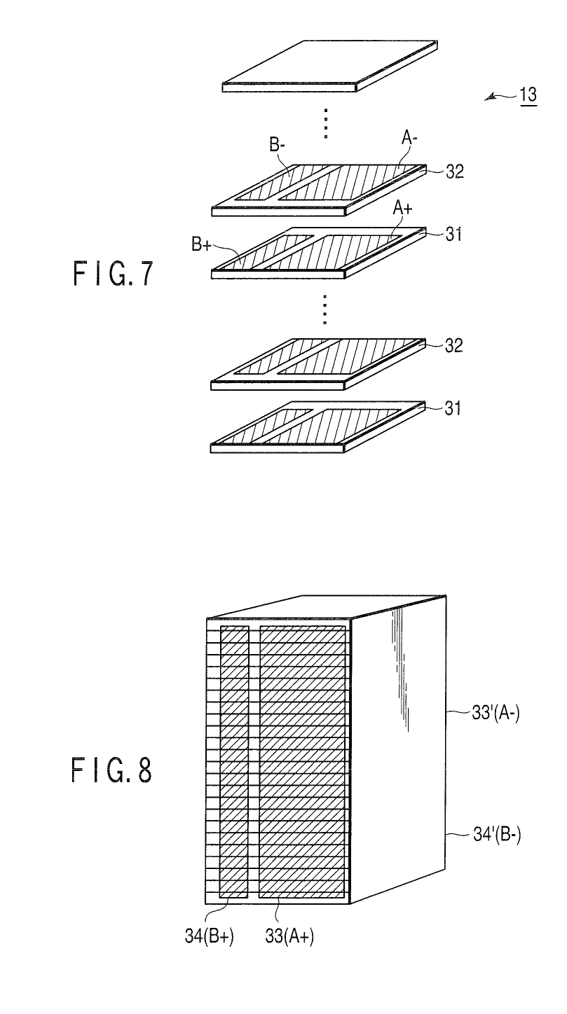

An external electrode is provided on the exposed side of each internal electrode. Specifically, as shown in FIG. 8, an external electrode 33 is provided on the side, on which the internal electrode A+ is exposed. Similarly, an external electrode 34 is provided on the side, on which the internal electrode B+ is exposed. Further, though not shown in the drawing, an external electrode 33′ is provided on the side, on which the internal electrode A− is exposed, and an external electrode 34′ is provided on the side, on which the internal electrode B− is exposed.

An explanation will be given of a method of assembling the ultrasonic oscillator 10 with reference to FIG. 6. The multilayer piezoelectric element 13 is inserted into a depressed multilayer piezoelectric element fitting part 18 of the square rod-shaped elastic body 11. An elastic holding body 12 is inserted along a pair of projected guidelines 17 provided in the square rod-shaped elastic body 11, butted against the multilayer piezoelectric element 13, and fixed with a screw 19 in the state in which a 100N compression stress is applied to the multilayer piezoelectric element 13. The contact surfaces of the multilayer piezoelectric element 13, square rod-shaped elastic body 11, and elastic holding body 12 are fixed by using an epoxy base adhesive. Thereafter, the frictional element 15 is bonded to the end face of the square rod-shaped elastic body 11.

As shown in FIGS. 2 and 3, the multilayer piezoelectric element 13 is provided on both sides of the square rod-shaped elastic body 11 opposite to each other at a predetermined angle with respect to the axis of the multilayer piezoelectric element 13. Hereinafter, when the internal electrodes in the opposing (arranged on the opposing sides) multilayer piezoelectric element elements 13 are connected, a sign “′” is added to the internal electrodes of one multilayer piezoelectric element 13 (e/g., A′+, B′−).

The internal electrodes B+ and B′− are connected to form an F+ terminal. Similarly, the internal electrodes B− and B′+ are connected to form an F− terminal. Hereinafter, such a connection is called a reverse connection. The F+ and F− terminals are used for detecting oscillation. Namely, an oscillation detection signal proportional to twisted oscillation of the multilayer piezoelectric element 13 described later is obtained based on the oscillation detection signal detected by the F+ and E− terminals.

There is another method of connection. The internal electrodes B+ and B′+ are connected to form an F+ terminal, and the internal electrodes B− and B′− are connected to form an F− terminal. This connection is called a forward connection. In this connection, an oscillation detection signal proportional to vertical oscillation of the multilayer piezoelectric element 13 is obtained based on the oscillation detection signal detected by the F+ and F− terminals.

In the first embodiment, the F+ and F− terminals are formed by the above-mentioned reverse connection, and an oscillation detection signal proportional to twisted oscillation of the multilayer piezoelectric element 13 is obtained based on the oscillation detection signal detected by the F+ and F− terminals.

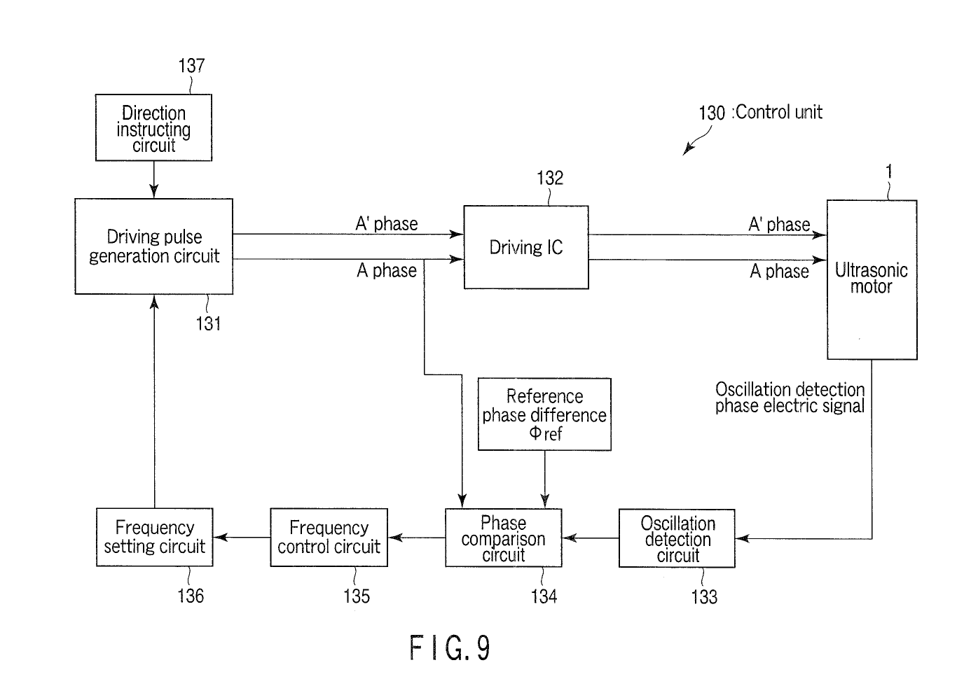

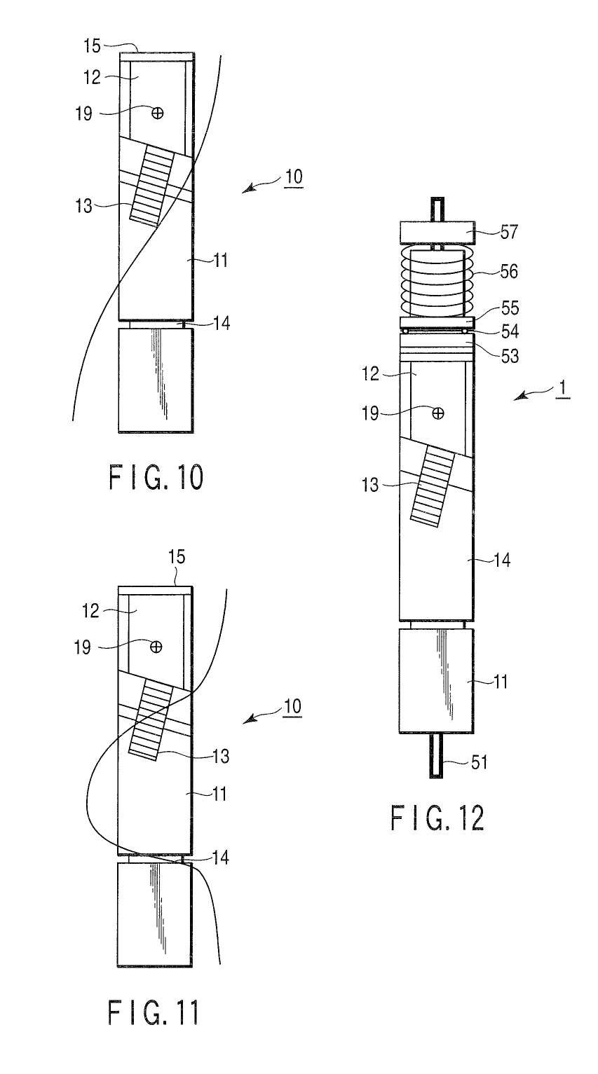

Hereinafter, an explanation will be given of a control unit of the ultrasonic motor 1 according to the first embodiment with reference to FIG. 9.

As shown in FIG. 9, a control unit 130 has a driving pulse generation circuit (signal generator) 131, a driving IC (driving circuit) 132, an oscillation detection circuit 133, a phase comparison circuit 134, a frequency control circuit 135, a frequency setting circuit 136, and a direction instructing circuit 137.

The driving pulse generation circuit 131 generates a two-phase driving control signal with a predetermined driving frequency and phase difference θ, and outputs the signal to a driving IC 132. The predetermined phase difference θ is about 90°, for example.

The driving IC 132 generates a two-phase alternating driving voltage with a predetermined phase difference and driving frequency, based on the two-phase driving control signal input from the driving pulse generation circuit 131, and applies the alternating driving signals to the external electrodes 33 and 33′ corresponding to the above-mentioned A-phase (internal electrodes A+ and A−) and A′-phase (internal electrodes A′+ and A′−).

The oscillation detection circuit 133 is connected to oscillation detection phase terminals (F+ and F−) through wiring, generates an oscillation detection signal proportional to twisted oscillation of the multilayer piezoelectric element 13, based on an analog signal (hereinafter, called an “oscillation detection phase electric signal”) from the oscillation detection phase terminals (F+ and F−). Specifically, the oscillation detection circuit 133 converts the oscillation detection phase electric signal entered through the wiring, to a digital signal by processing the signal, for example, adjusting the level, eliminating noises, and binarizing, and outputs the processed digital signal as an oscillation detection signal.

The phase comparison circuit 134 is configured to receive an oscillation detection signal output from the oscillation detection circuit 133, and an A-phase driving control signal applied to the driving IC 132. The phase comparison circuit 134 determines a phase difference φ between the oscillation detection signal and A-phase driving control signal, and a difference Δφ(=φ−φref) between the phase difference φ and a previously stored reference phase difference φref, and outputs a signal corresponding to the difference Δφ.

It is known that the ultrasonic motor 1 has a high efficiency in driving at a resonance frequency. However, a resonance frequency varies with an ambient temperature. Specifically, when an ambient temperature increases, a resonance frequency decreases. Therefore, when the ultrasonic motor 1 is controlled to obtain a maximum motor velocity, it is necessary to change a resonance frequency according to temperature changes.

In contrast, a resonance frequency and a phase difference φbetween the oscillation detection signal and A-phase driving control signal are in the relation in which the phase difference φ is always kept at a fixed value even if a temperature increases and a resonance frequency changes. This indicates that a constant motor velocity is always obtained by controlling a resonance frequency. Therefore, as described above, in the first embodiment, a resonance frequency is controlled, so that a phase difference φ between the oscillation detection signal and A-phase driving control signal is always kept at a fixed value.

In the first embodiment, a resonance frequency is controlled so that the reference phase difference φref is set to 3π/4, and the phase difference φ between the A-phase driving control signal and oscillation detection signal is kept at the reference phase difference φref. This is because a resonance frequency is taken at 3π/4, and the ultrasonic motor can be driven in a highest efficiency range. The value of reference phase difference φref is not limited, and can be desirably determined by a design item according to a driving efficiency of the ultrasonic motor 1, or a desired motor velocity.

The frequency control circuit 135 is configured to receive the difference Δφ from the phase comparison circuit 134. Based on the difference Δφ, the frequency control circuit 135 determines a frequency change amount Δf to reduce the difference Δφ to zero, and outputs the frequency change amount Δf. Specifically, the frequency control circuit 135 outputs a change amount +Δf to increase the frequency by a predetermined amount, when the difference Δφ is a positive value, and outputs a change amount −Δf to decrease the frequency by a predetermined amount, when the difference Δφ is a negative value. As described above, a frequency is sequentially controlled based on the difference Δφ in this embodiment.

The frequency control circuit 136 is configured to receive the frequency change amount Δf from the frequency control circuit 135. The frequency control circuit 136 has an oscillator, and a frequency divider, for example. The frequency control circuit 136 generates a clock signal increased or decreased according to the change amount Δf from the frequency control circuit 135, and outputs the clock signal to the driving pulse generation circuit 131.

The driving pulse generation circuit 131 is configured to receive a direction instructing signal from the direction instructing circuit 137. The driving pulse generation circuit 131 changes the phase difference θ of a two-phase driving control signal output to the driving IC 132 according to a direction instructing signal. Thereby, the direction of a substantially elliptical oscillation generated in the frictional element 15 of the ultrasonic oscillator 10 can be changed to forward and reverse directions.

Next, the function of the control unit 130 will be explained.

First, the driving pulse generation circuit 131 inputs a two-phase driving control signal with a predetermined driving frequency and phase difference θ (=90°) to the driving IC 132. Based on this input, a two-phase alternating driving voltage with a predetermined phase difference and driving frequency is applied to the A-phase external electrode 33 (internal electrodes A+ and A−) and A′-phase external electrode 33′ (internal electrodes A′+ and A′−) of the ultrasonic oscillator 10. Thereby, vertical oscillation and twisted oscillation are simultaneously excited in the ultrasonic oscillator 10, and elliptical oscillation is excited at the position of the frictional member 15.

An oscillation detection phase electric signal corresponding to the vertical oscillation mode of the ultrasonic oscillator 10 is input to the oscillation detection circuit 133 through the oscillation detection phase terminals (F+ and F−) and wiring. The oscillation detection phase electric signal is converted to a digital signal in the oscillation detection circuit 133, and input to the phase comparison circuit 134 as an oscillation detection signal. The oscillation detection signal input to the phase comparison circuit 134 is compared with an A-phase driving control signal, thereby a phase difference φ is obtained. Further, the difference Δφ between the phase difference φ and reference phase difference φref is obtained, and a signal corresponding to the difference Δφ is output to the frequency control circuit 135. The frequency control circuit 135 determines a sign (plus or minus) of the frequency change amount Δf based on the sign (plus or minus) of the difference Δφ, and the change amount Δf is output to the frequency setting circuit 136. The frequency setting circuit 136 generates a clock signal changed in frequency according to the change amount Δf, and outputs the clock signal to the driving pulse generation circuit 131. Thereby, feedback control is performed so that the phase difference φ between the A-phase driving control signal and oscillation detection signal becomes a reference phase difference φref, and the ultrasonic motor 1 can be driven at a desired frequency in response to temperature changes. Therefore, the motor can be always stably driven regardless of temperature changes.

As explained above, a driving frequency is changed, so that a phase difference between the twisted oscillation detection signal of oscillation detection phase and the A-phase driving control signal always becomes a predetermined value.

Next, the operation of the ultrasonic oscillator 10 will be explained.

The ultrasonic oscillator 10 is sized to use substantially the same frequency Fr (36 kHz) for exciting resonant vertical oscillation having a node at one location (mode displacement in resonant vertical oscillation is indicated by a solid line in FIG. 10) and resonant twisted oscillation having a node at two locations (mode displacement in resonant twisted oscillation is indicated by a solid line in FIG. 11).

In the resonant twisted oscillation, displacement is zero, or a node, on the axis in the longitudinal direction. Therefore, the position of the screw 20 shown in FIG. 6 is a node common to the vertical oscillation and twisted oscillation.

Resonant vertical oscillation can be excited by applying an alternating voltage with a frequency of 36 kHz and amplitude of 20 Vp-p to the external electrode 33 (internal electrodes A+ and A−), and an alternating voltage of the same phase, frequency and amplitude to the external electrode 33′ (internal electrodes A′+ and A′−).

Resonant twisted oscillation can be excited by applying an alternating voltage with a frequency of 36 kHz and amplitude of 20 Vp-p to the external electrode 33 (internal electrodes A+ and A−), and an alternating voltage of the same frequency, amplitude and a reverse phase to the external electrode 33′ (internal electrodes A′+ and A′−)

When an alternating voltage with a frequency of 36 kHz and amplitude of 20 Vp-p to the external electrode 33 (internal electrodes A+ and A−), and an alternating voltage of the same frequency, amplitude and a phase different by 900 to the external electrode 33′ (internal electrodes A′+ and A′−), resonant vertical oscillation and resonant twisted oscillation are combined, and elliptical oscillation can be excited at the position of the frictional element 15.

At this time, a detection signal proportional to the twisted oscillation is output from the oscillation detection terminals (F+ and F−).

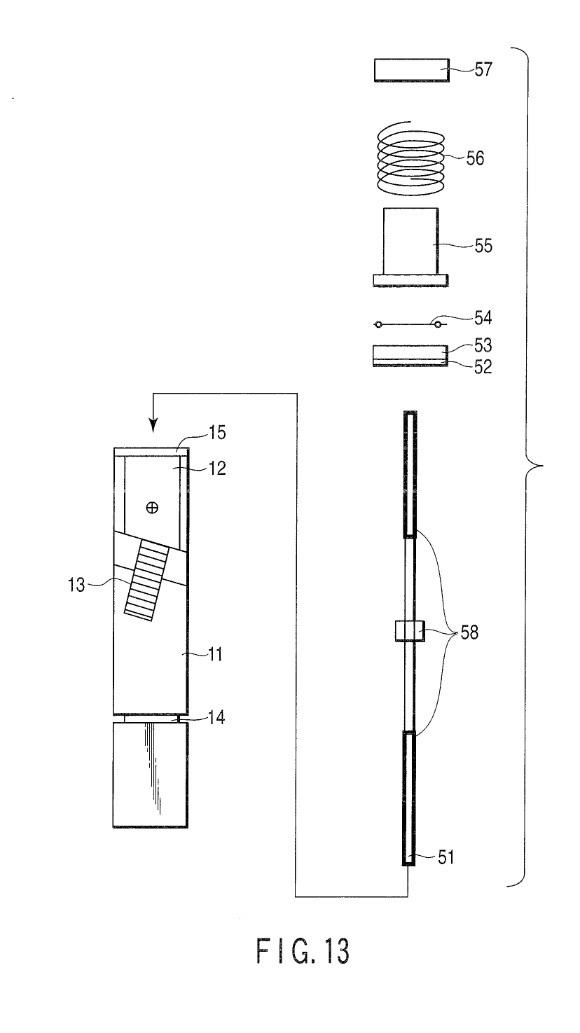

Hereinafter, an explanation will be given of the configuration and operation of the ultrasonic motor 1 according to the first embodiment with reference to FIG. 12 and FIG. 13.

FIG. 12 is a side view of the ultrasonic motor 1 using the ultrasonic oscillator 10. FIG. 13 is an exploded view of the ultrasonic motor 1 using the ultrasonic oscillator 10.

An axis 51 is inserted into a through hole 16 of the ultrasonic oscillator 10. As shown in FIG. 13, the axis 51 is provided with a screw 58 at the center and both ends. The screw 58 at the center is engaged with the screw 20 of the ultrasonic oscillator 10, and is bonded and fixed.

At the upper end of the ultrasonic oscillator 10, a rotor 53 is pressed and fixed by a spring 56 through a thrust bearing 54 and a spring holder 55. The pressing force is adjusted by a nut 57. At the bottom of the circular rotor 53, a circular sliding plate 52 made of zirconia ceramics is bonded. When the ultrasonic motor 1 is fixed, the axis 51 projected from the bottom is inserted into a not-shown base.

As described above, an alternating voltage with a frequency of 36 kHz, amplitude of 20 Vp-p, and a phase difference of +90° or −90° is applied to the A-phase (internal electrodes A+ and A−) and A′ phase (internal electrodes A′+ and A′−) of the ultrasonic oscillator 10. Thereby, the rotor 53 is rotated clockwise or counterclockwise.

Vertical and twisted resonance frequencies vary with changes in temperature and load. Thus, it is necessary to trace a driving frequency according to the changes in temperature and load. In the ultrasonic motor according to the first embodiment, an oscillation detection signal is output from the oscillation detection terminals (F+ and F−) in proportion to twisted oscillation as described above. Therefore, a resonance frequency can be traced by referring to the oscillation detection signal.

Namely, a driving frequency is changed by the above control, so that a phase difference between a twisted oscillatIon detection signal detected by the oscillation detection phase terminals (F+ and F−), and an A-phase (internal electrodes A+ and A−) driving control signal is kept at a predetermined value.

In the first embodiment, either tracing a resonance frequency by the phase of the oscillation detection terminals (F+ and F−), or tracing to have a maximum amplitude is permitted The multilayer piezoelectric element 13 may be provided either on opposing two sides, or on four sides, without departing from a range conforming to the principle of driving. Thereby, the output of the ultrasonic motor 1 can be increased.

As explained above, according to the first embodiment, even if a temperature or load changes, the motor can be driven at a most suitable driving frequency. It is possible to provide an ultrasonic motor, which is configured to be driven at an optimum frequency even if an ambient temperature and load are changed, and is constructed simple, and is reducible in costs and dimensions.

### Second Embodiment

Hereinafter, an explanation will be given of an ultrasonic motor according to a second embodiment with reference to the accompanying drawings. To avoid overlaps, an explanation will be given of only the different points from the ultrasonic motor of the first embodiment.

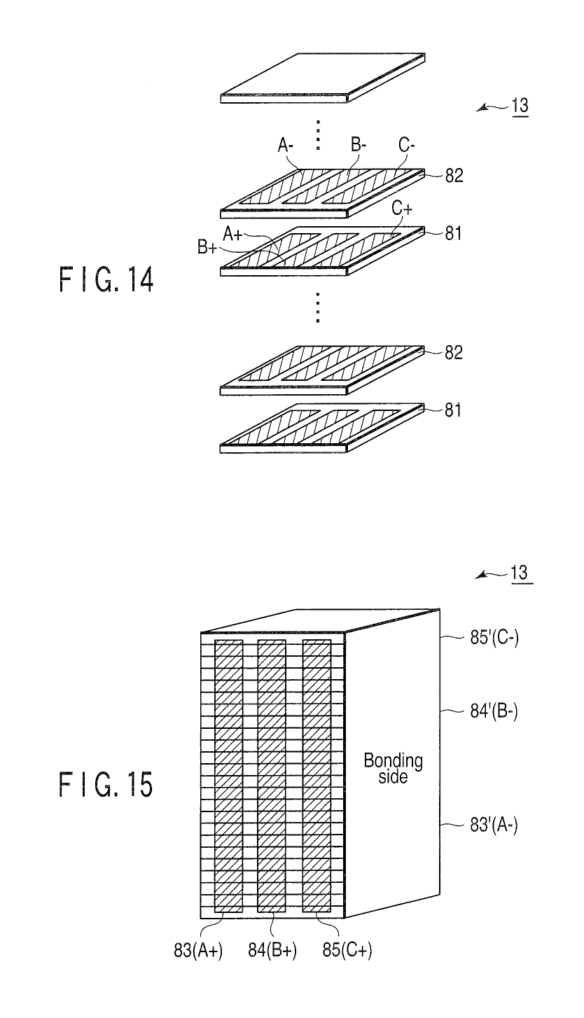

FIG. 14 is an exploded view showing the configuration of a multilayer piezoelectric element 13, which is one of the characteristic parts of the second embodiment.

As shown in FIG. 14, in the multilayer piezoelectric element 13, a piezoelectric plate 81 and a piezoelectric plate 82 are alternately laminated. Such a multilaver structure may be made by using an adhesive, or by baking the laminated plates in one piece.

More specifically, the piezoelectric plate 81 has three divided internal electrodes A+, B+ and C+ as shown in FIG. 14. Similarly, the piezoelectric plate 82 has three divided internal electrodes A−, B− and C− as shown in FIG. 14.

The internal electrodes A+ and A− are used for driving. The internal electrodes B+ and B−, and C+ and C− are used for detecting oscillation. The functions of driving and detecting oscillation assigned to the internal electrodes may be different.

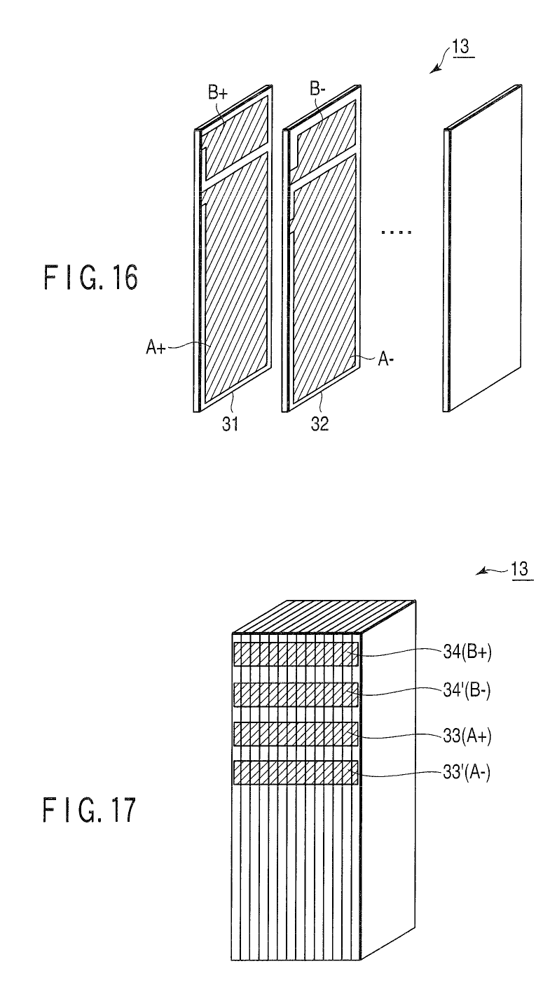

An external electrode is provided on the exposed side of each internal electrode. More specifically, as shown in FIG. 15, an external electrode 83 is provided on the side on which the internal electrode A+ is exposed. Similarly, an external electrode 84 is provided on the side on which the internal electrode B+ is exposed. An external electrode 85 is provided on the side on which the internal electrode C+ is exposed. Further, though not shown in the drawing, an external electrode 33′ is provided on the side on which the internal electrode A− is exposed, an external electrode 34′ is provided on the side on which the internal electrode B− is exposed, and an external electrode 35′ is provided on the side on which the internal electrode C− is exposed.

The forward connection is made for the internal electrodes B+ and B−. Namely, the internal electrodes B+ and B′+ are connected to form an F+ terminal, and the internal electrodes B− and B′− are connected to form an F− terminal. For the internal electrodes C+ and C−, the reverse connection is made. Namely, the internal electrodes C+ and C′− are connected to form an F2+ terminal. Similarly, the internal electrodes C− and C′+ are connected to form an F2− terminal.

In the configuration explained above, an oscillation detection signal proportional to vertical oscillation can be obtained from the oscillation detection phase terminals F1+ and F1−. An oscillation detection signal proportional to twisted oscillation can be obtained from the oscillation detection phase terminals F2 and F2−. A driving frequency is changed, so that a phase difference between the oscillation detection signal proportional to twisted oscillation and the applied voltage signal always becomes a predetermined value.

Vertical and twisted resonance frequencies vary with changes in temperature and load. Thus, it is necessary to trace a driving frequency according to the changes in temperature and load. In the ultrasonic motor according to the second embodiment, an oscillation detection signal proportional to vertical oscillation is output from the terminals F+ and F− as described above. An oscillation detection signal proportional to twisted oscillation is output from the terminals F2+ and F2−. Therefore, a resonance frequency can be traced by referring to the amplitude or phase of these oscillation detection signals.

The control for obtaining an oscillation detection signal proportional to vertical oscillation from the oscillation detection phase terminals F1+ and F1− is the same as the control for obtaining an oscillation detection signal proportional to twisted oscillation from the terminals F+ and F− explained in the first embodiment.

As explained above, according to the second embodiment, it is possible to provide an ultrasonic motor having the following effects in addition to the same effects as the ultrasonic motor according to the first embodiment.

Namely, in the ultrasonic motor according to the second embodiment, it is possible to control a shape of elliptical oscillation at the position of the frictional element 15 by combining resonant vertical oscillation and resonant twisted oscillation in the ultrasonic oscillator 10. By this control, it is possible to efficiently control the ultrasonic motor 10, and to absorb differences among ultrasonic oscillators.

### Third Embodiment

Hereinafter, an explanation will be given of an ultrasonic motor according to a third embodiment with reference to the accompanying drawings. To avoid overlaps, an explanation will be given of the different points from the ultrasonic motor of the first embodiment.

FIG. 16 is an exploded view showing a configuration of a multilayer piezoelectric element 13, which is one of the characteristic parts of the third embodiment.

As shown in FIG. 16, in the multilayer piezoelectric element 13, a piezoelectric plate 31 and a piezoelectric plate 32 are alternately laminated in the direction orthogonal to the expanding/constructing direction of the multilayer piezoelectric element 13. Namely, the main different point from the first embodiment is the laminating direction of the piezoelectric plates 31 and 32. Such a multilayer structure may be made by using an adhesive, or by baking the laminated plates in one piece.

More specifically, the piezoelectric plate 31 has two divided internal electrodes A+ and B+ as shown in FIG. 16. Similarly, the piezoelectric plate 32 has two divided internal electrodes A− and B− as shown in FIG. 16.

The internal electrodes (A+ and A−) are used for driving. The internal electrodes (B+ and B−) are used for detecting oscillation. The functions of driving and detecting oscillation assigned to the internal electrodes may be different.

An external electrode is provided on the exposed side of each internal electrode. More specifically, as shown in FIG. 17, an external electrode 33 is provided on the side on which the internal electrode A+ is exposed. Similarly, an external electrode 34 is provided on the side on which the internal electrode B+ is exposed. Further, an external electrode 33′ is provided on the side on which the internal electrode A− is exposed, and an external electrode 34′ is provided on the side on which the internal electrode B− is exposed.

The internal electrodes B+ and B′− are connected to form an F+ terminal. Similarly, the internal electrodes B− and B′+are connected to form an F− terminal. Namely, in the third embodiment, the terminals F+ and F− are formed by the reverse connection, and an oscillation detection signal proportional to twisted oscillation of the multilayer piezoelectric element 13 is obtained based on the oscillation detection signals detected by the F+ and F− terminals.

As explained above, according to the third embodiment, it is possible to provide an ultrasonic motor having the following effects in addition to the same effects as the ultrasonic motor according to the first embodiment.

Namely, according to the third embodiment, the multilayer piezoelectric element 13 is formed by alternately laminating the piezoelectric plates 31 and 32 in the direction orthogonal to the expanding/contracting direction of the multilayer piezoelectric element 13, thereby realizing a thinner multilayer piezoelectric element 13, and a reduced-size ultrasonic motor.

### Fourth Embodiment

Hereinafter, an explanation will be given of an ultrasonic motor according to a fourth embodiment with reference to the accompanying drawings. To avoid overlaps, an explanation will be given of the different points from the ultrasonic motor of the first embodiment.

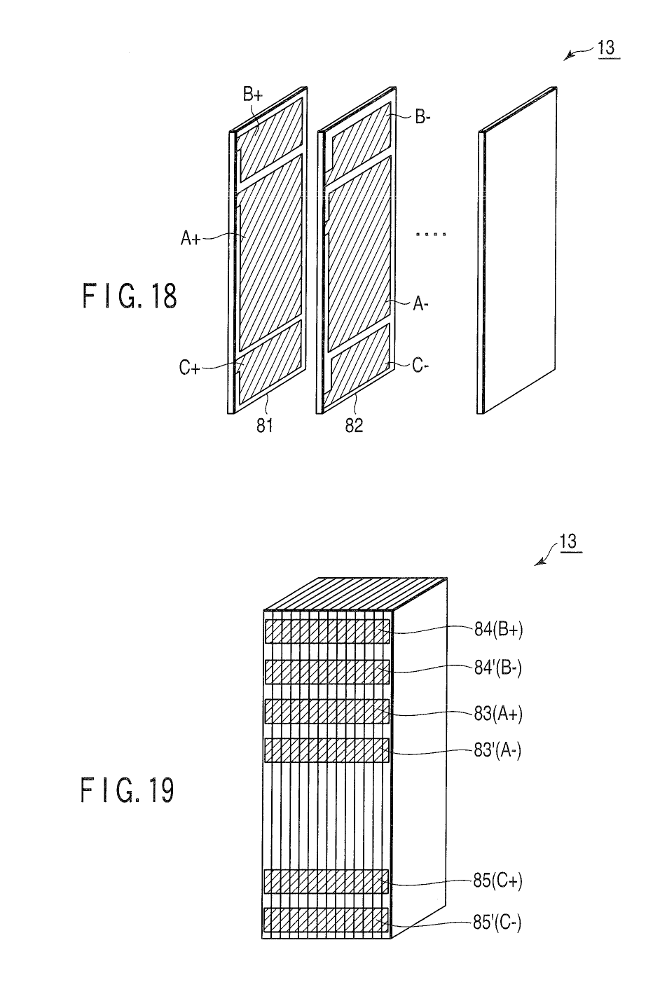

FIG. 18 is an exploded view showing a configuration of a multilayer piezoelectric element 13, which is one of the characteristic parts of the third embodiment.

As shown in FIG. 18, in the multilayer piezoelectric element 13, a piezoelectric plate 81 and a piezoelectric plate 82 are alternately laminated in the direction orthogonal to the expanding/constructing direction of the multilayer piezoelectric element. Namely, the main different point from the second embodiment is the laminating direction of the piezoelectric plates 81 and 82. Such a multilayer structure may be made by using an adhesive, or by baking the laminated plates in one piece.

More specifically, the piezoelectric plate 81 has three divided internal electrodes A+, B+ and C+ as shown in FIG. 17. Similarly, the piezoelectric plate 82 has three divided internal electrodes A−, B− and C− as shown in FIG. 17.

The internal electrodes (A+ and A−) are used for driving. The internal electrodes (B+ and B−) and (C+ and C−) are used for detecting oscillation. The functions of driving and detecting oscillation assigned to the internal electrodes may be different.

An external electrode is provided on the exposed side of each internal electrode. More specifically, as shown in FIG. 19, an external electrode 83 is provided on the side on which the internal electrode A+ is exposed. Similarly, an external electrode 84 is provided on the side on which the internal electrode B+ is exposed. An external electrode 85 is provided on the side on which the internal electrode C+ is exposed. Further, an external electrode 83′ is provided on the side on which the internal electrode A− is exposed, an external electrode 84′ is provided on the side on which the internal electrode B− is exposed, and an external electrode 85′ is provided on the side on which the internal electrode C− is exposed.

The forward connection is made for the internal electrodes (B+ and B−). Namely, the internal electrodes B+ and B′+ are connected to form an F1+ terminal, and the internal electrodes B− and B′− are connected to form an F1− terminal. For the internal electrodes C+ and C−, the reverse connection is made. Namely, the internal electrodes C+ and C′− are connected to form an F2+ terminal. Similarly, the internal electrodes C− and C′+ are connected to form an F2− terminal.

As explained above, according to the fourth embodiment, it is possible to provide an ultrasonic motor having the following effects in addition to the same effects as the ultrasonic motor according to the second embodiment.

Namely, according to the fourth embodiment, the multilayer piezoelectric element 13 is formed by alternately laminating the piezoelectric plates 81 and 82 in the direction orthogonal to the expanding/contracting direction of the multilayer piezoelectric element 13, thereby realizing a thinner multilayer piezoelectric element 13, and a reduced-size ultrasonic motor.

The present invention has been explained herein based on the first to fourth embodiments. The invention is not limited to these embodiments. Modifications and applications of the invention are possible within the essential characteristics of the invention. For example, the invention may be applied to a configuration without using the square rod-shaped elastic body 11 (the ultrasonic oscillator 10 mainly consists of a piezoelectric sheet and an internal electrode).

Further, the embodiments described herein include various steps of the invention. The invention may be embodied in various forms by combining the disclosed constituent elements. For example, even if some of the constituent elements are deleted, the invention may be extracted as modifications, as long as the theme to be solved by the invention can be resolved, and the effects of invention are obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor, which rotates a rotor by elastic movement generated by simultaneously exciting vertical oscillation and twisted oscillation in an ultrasonic oscillator, by using expanding and contracting oscillations of a multilayer piezoelectric element formed by laminating two kinds of piezoelectric sheet,
wherein the multilayer piezoelectric element is formed by alternately laminating a first piezoelectric sheet and a second piezoelectric sheet,
the first piezoelectric sheet has a first internal electrode which is divided into two or more parts, and each divided part is exposed to a peripheral edge of the piezoelectric sheet, and
the second piezoelectric sheet has an internal electrode which has a polarity reverse to the first internal electrode, and is divided into two or more parts, and each divided part is exposed to a peripheral edge of the piezoelectric sheet.

2. The ultrasonic motor according to claim 1, wherein a direction of laminating the piezoelectric sheet is a direction related to expansion and contraction of the ultrasonic oscillator.

3. The ultrasonic motor according to claim 1, wherein a direction of laminating the piezoelectric sheet is a direction orthogonal to a direction of expansion and contraction of the ultrasonic oscillator.

4. The ultrasonic motor according to claim 1, wherein two or more means two.

5. The ultrasonic motor according to claim 1, wherein two or more means three.
